(19) United States
(12) Patent Application Publication
(10) Pub. No.: US 2020/0369908 A1
(43) Pub. Date: Nov. 26, 2020

(54) GAS BARRIER FILM AND METHOD FOR PRODUCING SAME

(71) Applicant: Daicel Value Coating Ltd., Tokyo (JP)

(72) Inventors: Takashi SAIO, Tokyo (JP); Kiyonori FUJIMOTO, Tokyo (JP)

(73) Assignee: Daicel Value Coating Ltd., Tokyo (JP)

(21) Appl. No.: 16/753,451

(22) PCT Filed: Oct. 10, 2018
(86) PCT No.: PCT/JP2018/037666

§ 371 Date: Apr. 3, 2020

(30) Foreign Application Priority Data
Jan. 30, 2018 (JP) 2018-014080

(51) Int. Cl. C09D 127/08; C09D 7/63; C01B 33/113; B65D 65/42

(52) U.S. Cl. CPC C09D 127/08; B65D 65/42; C01B 33/113; C09D 7/63

(57) ABSTRACT

Provided is a gas barrier film having at least one surface of a substrate layer covered with a coating layer containing a first vinylidene chloride copolymer containing a carbonyl group, with an inorganic layer interposed between the substrate layer and the coating layer. The obtained gas barrier film can improve the high barrier properties against gases such as water vapor, and can improve interlayer adherence even with a laminated structure of an inorganic layer and an organic layer. An integral value of signals at from 170 to 180 ppm in a ¹³C-NMR spectrum of the first vinylidene chloride copolymer may be at least 0.001 times an integral value of signals at from 80 to 85 ppm. The first vinylidene chloride copolymer may further include a cyano group. The coating layer may further include a second vinylidene chloride copolymer, in a ¹³C-NMR spectrum of which, an integral value of signals at from 170 to 180 ppm is less than 0.001 times an integral value of signals at from 80 to 85 ppm. The coating layer may further include a silane coupling agent. The inorganic layer may be silicon oxide.

### TECHNICAL FIELD

The present invention relates to a gas barrier film for preventing the permeation of gas such as water vapor in various fields such as food products, pharmaceuticals, agricultural products, electronic devices, and optical equipment, and to a method for producing the same.

### BACKGROUND ART

In various fields such as food products, pharmaceuticals, agricultural products, electronic devices, and optical equipment, gas barrier films having barrier properties against gases such as water vapor and oxygen are used to suppress quality deterioration due to gases such as water vapor and oxygen. In addition, in these fields, applications that require transparency also exist from the perspective of visibility of the contents and optical characteristics. Films having various transparent barrier layers are known as such transparent gas barrier films, and as a transparent moisture-proof film having excellent balance of various properties such as heat resistance and processability, a laminated film obtained by laminating, on a substrate layer, an inorganic barrier layer formed of an inorganic material and an organic barrier layer formed from a polyvinylidene chloride-based resin is also known.

JP 3441594 B (Patent Document 1) discloses a barrier composite film in which a substrate film layer is covered at least one surface thereof with a barrier resin coating layer containing a silane coupling agent with an inorganic thin film layer constituted of a silicon oxide interposed therebetween, wherein the barrier resin coating layer includes a vinylidene chloride-based copolymer or an ethylene-vinyl alcohol copolymer.

In addition, JP 2017-114079 A (Patent Document 2) discloses a barrier film having a substrate film on at least one surface of a polyvinyl chloride-based resin layer containing a polyvinylidene chloride-based resin as a main component and having a specific absorption peak height in an infrared absorption spectrum, and further having an inorganic material layer between the polyvinylidene chloride-based resin layer and the substrate film layer.

However, with these gas barrier films, the moisture proofness (a property of preventing moisture absorption of contents) and moisture desorption prevention property (property of preventing the dryness of the contents) are not sufficient in applications requiring advanced moisture proofness and moisture desorption prevention properties, including for example applications in solar cells and pharmaceutical products, in recent years. For example, in the field of pharmaceutical packaging, when a liquid is encapsulated, the concentration of the contents changes due to moisture desorption, and therefore advanced high gas barrier films are required. However, gas barrier properties are prone to deterioration when a liquid is encapsulated.

Note that the organic barrier layer formed of a polyvinylidene chloride resin and the inorganic barrier layer have a laminated structure of the organic barrier layer and the inorganic barrier layer, and thus it is difficult to improve adherence between layers, and it is difficult to improve gas barrier properties while maintaining adherence between the layers. In particular, the organic barrier layer is typically produced by coating of a liquid composition containing a solvent, and therefore it is desirable to reduce the residual solvent as much as possible, but the reduction of residual solvent is in a trade-off relationship with interlayer adherence.

### CITATION LIST

### Patent Document

Patent Document 1: JP 3441594 B (claims 1, 6 and 8)
Patent Document 2: JP 2017-114079 A (claims 1 to 3)

### SUMMARY OF INVENTION

### Technical Problem

Therefore, an object of the present invention is to provide a gas barrier film having high barrier properties against gases such as water vapor, and having high interlayer adherence even with a laminated structure of an inorganic layer and an organic layer, and to provide a method for producing the same.

Another object of the present invention is to provide a gas barrier film that has high interlayer adherence and for which the residual solvent can be reduced, and to provide a method for producing the same.

Yet another object of the present invention is to provide a gas barrier film that excels in mechanical properties such as bending resistance, and can maintain moisture proofness and moisture desorption prevention property over an extended period of time, and to provide a method for producing the same.

Another object of the present invention is to provide a gas barrier film that is transparent and thereby enables confirmation of the contents, and to provide a method for producing the same.

### Solution to Problem

As a result of diligent research to achieve the problem described above, the inventors of the present invention discovered that by covering at least one surface of a substrate layer with a coating layer containing a first polyvinylidene chloride copolymer containing a carbonyl group with an inorganic layer interposed therebetween, high barrier properties against gases such as water vapor can be improved, and interlayer adherence can be improved even with a laminated structure of an inorganic layer and an organic layer, and thereby arrived at the present invention.

That is, a gas barrier film according to an embodiment of the present invention includes a substrate layer, an inorganic layer covering at least one surface of the substrate layer, and a coating layer covering the inorganic layer and including a first vinylidene chloride copolymer containing a carbonyl group. In a ¹³C-NMR spectrum of the first vinylidene chloride copolymer, an integral value of signals at from 170 to 180 ppm may be at least 0.001 times an integral value of signals at from 80 to 85 ppm. The first vinylidene chloride copolymer may further contain a cyano group. The coating layer may further include a second vinylidene chloride copolymer, in a ¹³C-NMR spectrum of which, an integral value of signals at from 170 to 180 ppm is less than 0.001 times an integral value of signals at from 80 to 85 ppm. A weight ratio of the first polyvinylidene chloride copolymer to the second vinylidene chloride copolymer is approximately former/latter=99/1 to 30/70. The coating layer may further include a silane coupling agent. The inorganic layer may be silicon oxide. The gas barrier film may have a water vapor transmission rate at 40° C. and 90% RH of less than 0.1 g/m²/day.

The present invention also includes a method for producing the gas barrier film, the method including a first laminating step of forming an inorganic layer on at least one surface of a substrate layer, and a second laminating step of forming a coating layer on the inorganic layer. In the second laminating step, a liquid composition for forming the coating layer may be applied, and then dried and further aged. The aging may be performed in a wet state. A content percentage of water in the liquid composition for forming the coating layer may be 0.15 wt. % or greater.

### Advantageous Effects of Invention

In the present invention, at least one surface of the substrate layer is covered with a coating layer including a first vinylidene chloride copolymer containing a carbonyl group, with an inorganic layer interposed between the substrate layer and the coating layer, and therefore, high barrier properties against gases such as water vapor can be improved, and interlayer adherence can be improved even with a laminated structure of an inorganic barrier layer and an organic barrier layer. Furthermore, when a coating layer is formed by coating using a solvent, adherence can be improved even if the usage amount of the solvent is low, and therefore, the residual solvent can be reduced while maintaining interlayer adherence. Furthermore, the gas barrier film excels in mechanical properties such as bending resistance, and can maintain moisture proofness and a moisture desorption prevention property over an extended period of time, and because the gas barrier film is transparent, the contents can be confirmed.

### BRIEF DESCRIPTION OF DRAWINGS

FIG. 1 is a ¹³C-NMR spectrum of a first vinylidene chloride copolymer and a second vinylidene chloride copolymer used in the examples.

FIG. 2 is a graph for comparing the gas barrier properties of a gas barrier film obtained in Example 1 and a commercially available gas barrier film.

### DESCRIPTION OF EMBODIMENTS

Gas Barrier Film

A gas barrier film according to an embodiment of the present invention includes a substrate layer, an inorganic layer covering at least one surface of the substrate layer, and a coating layer covering the inorganic layer, and the coating layer includes a first vinylidene chloride copolymer containing a carbonyl group, and therefore, gas barrier properties and interlayer adherence can be achieved in a compatible manner. The inorganic layer and the coating layer may each be formed on at least one surface of the substrate layer or may also be formed on both surfaces thereof, but are usually formed on one surface of the substrate layer.

Substrate Layer

The material of the substrate layer is not particularly limited, but a polymer is preferable from the perspective of excelling in transparency, moldability, and the like. Examples of the polymer include olefinic resins (for example, polyethylene, ethylene-ethyl acrylate copolymers, ionomers, polypropylene, ethylene-propylene copolymers, and poly-4-methylpentene-1), acrylonitrile-based resins (for example, polyacrylonitrile), styrene-based resins (for example, polystyrene, styrene-acrylonitrile copolymers, and styrene-acrylonitrile-butadiene copolymers), vinyl chloride-based resins (for example, polyvinyl chloride), vinyl alcohol-based resins (for example, polyvinyl alcohol and ethylene-vinyl alcohol copolymers), fluororesins (for example, polytetrafluoroethylene, polytrifluorochloroethylene, and ethylene fluoride-propylene copolymers), polyesters (for example, polyethylene terephthalate, polyethylene-2,6-naphthalate, polybutylene terephthalate, and other polyalkylene arylates; liquid crystal polyesters; and polyarylates), polycarbonates (for example, bisphenol-A type polycarbonates), polyamides (for example, polyamide 6, polyamide 11, polyamide 12, polyamide 66, polyamide 610, polyamide 6/66, polyamide 66/610, and other aliphatic polyamides; and aromatic polyamides), polyimide based resins (for example, polyamide-imide, polyimide, and polyetherimide), polysulfone-based resins (for example, polysulfones and polyethersulfones), polyether ketone-based resins (for example, polyether ether ketones), polyphenylene sulfide-based resins (for example, polyphenylene sulfide), polyphenylene oxide-based resins (for example, polyphenylene oxide), polyparaxylene-based resins (for example, polyparaxylene), cellulosic resins (for example, cellophane), and rubbers (for example, hydrochloric acid rubber).

These polymers can be used alone or in a combination of two or more. Among these polymers, olefinic resins such as polypropylene, polyesters such as polyethylene terephthalate, and polyamides such as polyamide 6 are commonly used, and polyesters (in particular, polyalkylene arylate-based resins) are preferable.

The polyalkylene arylate-based resin includes a homopolyester or copolyester containing an alkylene arylate unit as a main component at a ratio of, for example, 50 mol % or greater, preferably from 75 to 100 mol %, and even more preferably from 80 to 100 mol % (in particular, from 90 to 100 mol %). Examples of copolymerizable monomers constituting the copolyester includes a dicarboxylic acid component (for example, a C₈₋₂₀ aromatic dicarboxylic acid such as terephthalic acid, isophthalic acid, 2,7-naphthalene dicarboxylic acid, or 2,5-naphthalene dicarboxylic acid; a C₄₋₁₂ alkane dicarboxylic acid such as adipic acid, azelaic acid, or sebacic acid; and a C₄₋₁₂ cycloalkane dicarboxylic acid such as 1,4-cyclohexane dicarboxylic acid), a diol component (for example, ethylene glycol, propylene glycol, butanediol, neopentyl glycol or other such C₂₋₁₀ alkanediol, diethylene glycol, polyethylene glycol, or other such C₂₋₄ alkylene glycols, 1,4-cyclohexane dimethanol or other such C₄₋₁₂ cycloalkanediols, and bisphenol A or other such aromatic diols), and a hydroxycarboxylic acid component (such as p-hydroxybenzoic acid and p-hydroxyethoxybenzoic acid). These copolymerizable monomers can be used alone or in a combination of two or more types. Examples of the polyalkylene arylate resins include poly C₂₋₄ alkylene terephthalate resins such as polyethylene terephthalate (PET), polytrimethylene terephthalate, and polybutylene terephthalate; and poly C₂₋₄ alkylene naphthalate resins such as polyethylene naphthalate, polytrimethylene naphthalate, and polybutylene naphthalate.

The number average molecular weight of the polyalkylene arylate resin can be selected from approximately a range of from 5000 to 1000000 using gel permeation chromatography (GPC) based on calibration with polystyrene, and is approximately, for example, from 10000 to 500000, preferably from 12000 to 300000, and even more preferably approximately from 15000 to 100000.

When the substrate layer is formed from a polymer, the substrate layer can be formed using a commonly used film forming method, for example, an inflation method, a T-die method or other melt molding method, or a casting method using a solution.

The substrate layer formed of the polymer may be unstretched or may be uniaxially or biaxially stretched. As the stretching method, a commonly used stretching method can be used such as roll stretching, pressurized rolling stretching, belt stretching, tenter stretching, tube stretching, and stretching through a combination of these.

The stretch ratio can be set, as appropriate, in accordance with the desired characteristics of the substrate layer, and is approximately, for example, from 1.5 to 20 times, and preferably from 2 to 15 times, in at least one direction; and in the case of biaxially stretched polyester film (such as a PET film), the stretch ratios in the film draw-out direction (MD direction) and the width direction (TD direction) are each approximately, for example, from 2 to 8 times, preferably from 2 to 5 times, and even more preferably from 3 to 4 times. If the stretch ratio is too large, production of the stretched film itself may be difficult, and if the stretch ratio is too small, there is a possibility that the flexibility of the film may decrease.

In order to improve adherence to the inorganic layer, at least one surface of the substrate layer may be subjected to a surface treatment (for example, a corona discharge treatment, glow discharge treatment, plasma treatment, reverse sputtering treatment, flame treatment, chromic acid treatment, solvent treatment, surface roughening treatment, and ozone or ultraviolet irradiation treatment), and may have an easily adhesive layer.

The average thickness of the substrate layer is approximately, for example, from 3 to 200 μm, preferably from 5 to 150 μm, and more preferably from 10 to 100 μm.

Inorganic Layer

The inorganic layer typically contains a metal or metal compound, and is preferably composed of a metal or metal compound capable of forming a thin film (particularly a transparent thin film). Examples of such metals include the Group 2A elements of the periodic table, such as beryllium, magnesium, calcium, strontium, and barium; transition elements such as titanium, zirconium, ruthenium, hafnium, tantalum, and copper; the Group 2B elements of the periodic table, such as zinc; the Group 3B elements of the periodic table, such as aluminum, gallium, indium, and thallium; the Group 4B elements of the periodic table, such as silicon, germanium, and tin; and the Group 4B elements of the periodic table group, such as selenium and tellurium. Examples of the metal compound include oxides, nitrides, oxynitrides, halides, or carbides of the metal. These metals or metal compounds can be used alone or in a combination of two or more.

Of these metals or metal compounds, from the perspective of improving not only the gas barrier properties but also transparency, metal oxides, metal oxynitrides and metal nitrides of the Group 3B elements of the periodic table, such as aluminum, the Group 4B elements of the periodic table, such as silicon, and transition elements such as titanium are widely used, and aluminum oxide [compositional formula AlₓO_{y} (x, y>0)] and silicon oxide [compositional formula SiOₓ (0<x≤2)] are preferable. Furthermore, the silicon oxide may be silicon monoxide or silicon dioxide, but a silicon oxide that is of the compositional formula SiOx (1.2≤x≤1.9) is preferable.

The average thickness of the inorganic layer can be appropriately selected according to the film forming method, and may be approximately, for example, from 10 to 300 nm, preferably from 15 to 250 nm, and even more preferably from 20 to 200 nm (particularly, from 30 to 100 nm). In particular, from the perspectives of preventing the occurrence of cracks, etc., forming a uniform film, and maintaining the gas barrier properties, with a physical vapor phase method, the average thickness of the inorganic layer is preferably adjusted to approximately from 10 to 100 nm (in particular, from 15 to 80 nm), and with a chemical vapor phase method, the average thickness of the inorganic layer is preferably adjusted to approximately from 50 to 400 nm (in particular, from 100 to 300 nm). In a case where the thickness of the inorganic layer is too thin, there is a possibility that the gas barrier properties may be reduced, and in a case where the thickness is too high, there is a possibility that the flexibility will decline.

Coating Layer

The coating layer is laminated on the inorganic layer and includes a first polyvinylidene chloride copolymer containing a carbonyl group, and thereby can improve the gas barrier properties.

(A) First Vinylidene Chloride Copolymer

A first vinylidene chloride copolymer (vinylidene chloride-containing copolymer) favorably has a carbonyl group in addition to a repeating unit of vinylidene chloride serving as the main unit, and in the present invention, the content ratio of carbonyl groups in the copolymer can be evaluated with a ¹³C-NMR spectrum. Specifically, the integral value of signals at from 170 to 180 ppm derived from the carbonyl group may be at least 0.001 times the integral value of signals at 80 to 85 ppm derived vinylidene chloride, and is approximately, for example, from 0.001 to 0.1 times, preferably from 0.005 to 0.08 times, and even more preferably from 0.01 to 0.05 times (in particular, from 0.02 to 0.03 times). In a case where the integral value of signals at from 170 to 180 ppm is too small, there is a possibility that the gas barrier properties may decrease.

In the present specification and claims, the ¹³C-NMR spectrum can be measured by a method described in the examples below.

The introduced form of the carbonyl groups is not particularly limited, but is normally a form in which units having a carbonyl group are included as copolymerized units (copolymerizable monomer units) in random, block or graft forms (typically, an aspect including a random form) with respect to the vinylidene chloride units. Examples of monomers for forming a copolymerization unit containing a carbonyl group include (meth)acrylic acid, maleic acid, fumaric acid, itaconic acid, citraconic acid, crotonic acid, isocrotonic acid, mesaconic acid, angelic acid, and other ethylenically unsaturated carboxylic acids; methyl (meth)acrylate, ethyl (meth)acrylate, propyl (meth)acrylate, isopropyl (meth)acrylate, butyl (meth)acrylate, hexyl (meth)acrylate, octyl (meth)acrylate, 2-ethylhexyl (meth)acrylate, and other such C₁₋₁₈ alkyl (meth)acrylates; cyclopentyl (meth)acrylate, cyclohexyl (meth)acrylate, cyclooctyl (meth)acrylate, and other such C₄₋₁₀ cycloalkyl (meth)acrylates; hydroxyethyl (meth)acrylate, hydroxypropyl (meth)acrylate, hydroxybutyl (meth) acrylate, and other such hydroxy C₂₋₁₂ alkyl (meth)acrylates; methoxyethyl (meth)acrylate, methoxypropyl (meth)acrylate, methoxybutyl (meth)acrylate, ethoxybutyl (meth)acrylate and other such C₁₋₄ alkoxy C₂₋₁₂ alkyl (meth)acrylates; polyoxyethylene (meth)acrylate and other such poly C₂₋₄ oxyalkylene (meth)acrylates; phenyl (meth)acrylate and other such aryl (meth)acrylates; glycidyl (meth)acrylate and other such (meth)acrylates; and vinyl acetate, vinyl propionate, and other such vinyl ester-based monomers. These monomers can be used alone or in a combination of two or more. Of these, C₁₋₁₂ alkyl (meth)acrylates (in particular, C₁₋₆ alkyl (meth)acrylates), such as (meth)acrylic acid, methyl (meth)acrylate, and ethyl (meth)acrylate, are preferable.

The first vinylidene chloride copolymer may further contain a cyano group in addition to the carbonyl group. In the present invention, the content ratio of cyano groups in the copolymer can also be evaluated with the ¹³C-NMR spectrum. Specifically, an integral value of signals at from 120 to 125 ppm derived from cyano groups may be less than 0.15 times an integral value of signals at 80 to 85 ppm, and may be approximately, for example, from 0.001 to 0.14 times, preferably from 0.01 to 0.12 times, and even more preferably from 0.03 to 0.1 times (in particular, from 0.05 to 0.08 times). If the integral value of signals at from 120 to 125 ppm is too great, the gas barrier properties may decrease.

The introduced form of the cyano group is not particularly limited, but is normally a form in which units having a cyano group are included as copolymerized units with respect to vinylidene chloride units. Examples of monomers for forming a copolymerization unit containing a cyano group include vinyl cyanide-based monomers such as (meth)acrylonitrile. Of these, acrylonitrile is preferable.

The first vinylidene chloride copolymer may further contain other copolymerized units. Examples of monomers for forming other copolymerized units include vinyl chloride and other chlorine containing monomers other than vinylidene chloride; and butadiene, isoprene, and other such diene-based monomers. These monomers can be used alone or in a combination of two or more. Of these, vinyl chloride, vinyl acetate, and the like are widely used. The percentage of the other copolymerizable units is, in terms of all monomer units for copolymerization, 50 mol % or less, and is approximately for example, from 0.01 to 30 mol %, preferably from 0.1 to 20 mol %, and even more preferably from 1 to 10 mol %.

In the first vinylidene chloride copolymer, the percentage of vinylidene chloride units serving as a main unit may be, of the total monomer units of the copolymer, 30 mol % or greater (in particular, 50 mol % or greater), and for example, may be 70 mol % or greater (for example, from 70 to 99 mol %), preferably 75 mol % or greater (for example, from 75 to 99 mol %), more preferably 80 mol % or greater (for example, from 80 to 99 mol %), and in particular 90 mol % or higher (for example, from 90 to 99 mol %). In a case where the percentage of vinylidene chloride units is too low, there is a possibility that the gas barrier properties will decline.

The number average molecular weight of the first vinylidene chloride copolymer in gel permeation chromatography (GPC) based on calibration with polystyrene may be approximately, for example, from 10000 to 500000, preferably from 20000 to 250000, and more preferably from 25000 to 100000.

The first vinylidene chloride copolymer can be produced by a method of polymerizing appropriately combined monomers by a commonly used method such as suspension polymerization or emulsion polymerization.

(B) Second Vinylidene Chloride Copolymer

In addition to the first vinylidene chloride copolymer, the coating layer also contains a second vinylidene chloride copolymer having a carbonyl group content that is less than that of the first vinylidene chloride copolymer, and combination of both copolymers can improve the adherence between the layers.

In the second vinylidene chloride copolymer, an integral value signals at from 170 to 180 ppm in the ¹³C-NMR spectrum and derived from carbonyl groups is less than 0.001 times the integral value of signals at from 80 to 85 ppm in the ¹³C-NMR spectrum and derived from vinylidene chloride, and for example is 0.0009 times or less, preferably 0.0005 times or less, and even more preferably 0.0001 times or less, and may be substantially zero times (may be free of carbonyl groups). The integral value of signals at from 170 to 180 ppm is preferably small, and in a case where the integral value is too large, there is a possibility that interlayer adherence may be reduced.

In a case in which carbonyl groups are included, both the introduced form of the carbonyl group and the type of monomers for forming the copolymerized unit containing a carbonyl group are the same as those of the first vinylidene chloride copolymer.

The second vinylidene chloride copolymer may also contain a cyano group. In the present invention, the content ratio of cyano groups in the copolymer can also be evaluated with the ¹³C-NMR spectrum. Specifically, an integral value of signals at from 120 to 125 ppm may be at least 0.15 times an integral value of signals at from 80 to 85 ppm, and for example may be approximately from 0.15 to 0.5 times, preferably from 0.16 to 0.3 times, and even more preferably from 0.17 to 0.2 times (in particular, from 0.17 to 0.19 times). If the integral value of signals at from 120 to 125 ppm is too small, there is a concern that interlayer adherence may decrease.

Both the introduced form of the cyano group and the type of monomers for forming the copolymerized unit containing a cyano group are the same as those of the first vinylidene chloride copolymer.

The second vinylidene chloride copolymer may also further contain other copolymerized units. The type of monomers for forming the other copolymerized units and the proportion in the copolymer are similar to those of the first vinylidene chloride copolymer. The number average molecular weight can also be selected from the same range as the number average molecular weight of the first vinylidene chloride copolymer.

In the second vinylidene chloride copolymer, the percentage of vinylidene chloride units serving as a main unit may be, of the total monomer units of the copolymer, 30 mol % or greater (in particular, 50 mol % or greater), and for example, may be 70 mol % or greater (for example, from 70 to 99 mol %), preferably 75 mol % or greater (for example, from 75 to 99 mol %), more preferably 80 mol % or greater (for example, from 80 to 99 mol %), and in particular 90 mol % or greater (for example, from 90 to 99 mol %). In a case where the percentage of vinylidene chloride units is too low, there is a possibility that the gas barrier properties will decline.

The second vinylidene chloride copolymer can be produced by the same method as that of the first vinylidene chloride copolymer by appropriately selecting the type of monomers.

The weight ratio of the first vinylidene chloride copolymer to the second vinylidene chloride copolymer can be selected from a range of approximately the former/latter=from 99.9/0.1 to 10/90 (for example, from 99.5/0.5 to 20/80), and can be approximately, for example, from 99/1 to 30/70 (for example, from 98/2 to 40/60), preferably from 97/3 to 70/30 (for example, from 95/5 to 80/20), and more preferably from 93/7 to 85/15 (particularly, from 92/8 to 88/12). In a case where the proportion of the first vinylidene chloride copolymer is too low, there is a risk that the gas barrier properties will decline, and if the proportion of the second vinylidene chloride copolymer is too low, there is a risk that the effect of improving interlayer adherence may be reduced.

(C) Silane Coupling Agent

From the perspective of improving interlayer adherence, the coating layer may further include a silane coupling agent in addition to the vinylidene chloride copolymer.

Examples of the silane coupling agent include various compounds that can improve adherence to the inorganic layer and the substrate layer, including, for example, a silicon compound having an alkoxy group and at least one type of functional group selected from a halogen atom, an epoxy group, an amino group, a hydroxyl group, a mercapto group, a vinyl group, or a (meth)acryloyl group. In this silicon compound, the number of reactive functional groups is approximately from 1 to 3 (in particular, 1 or 2), and the number of alkoxy groups is approximately from 1 to 3 (in particular, 2 or 3).

Preferable silane coupling agents may be silicon compounds represented by the formula Y—(R)ₙ—SiX₃ [where, Y denotes one type of functional group selected from a halogen atom, an epoxy group, an amino group, a mercapto group, a vinyl group, and a (meth)acryloyl group, R denotes a hydrocarbon residue, X denotes an alkoxy group and may be the same or different, and n is 0 or 1].

With respect to Y in the formula, the halogen atom may be a fluorine, chlorine, bromine, or iodine atom, and is often a chlorine atom or a bromine atom. The epoxy group may be constituted of, for example, an epoxy ring produced by oxidation of an unsaturated bond of a hydrocarbon group (for example, an unsaturated double bond of a cycloalkenyl group such as a cyclopentenyl group, a cyclohexenyl group, or a cyclooctenyl group), or an epoxy ring of a glycidyl group. The amino group may be substituted with one or two lower alkyl groups (for example, a C₁₋₄ alkyl group such as a methyl, ethyl, propyl, isopropyl, or butyl group). Furthermore, the (meth)acryloyl group may be constituted by a (meth)acryloyloxy group. Alkoxy groups include, for example, C₁₋₄ alkoxy groups such as methoxy, ethoxy, propoxy, isopropoxy, butoxy, isobutoxy, s-butoxy, and t-butoxy groups. Preferred alkoxy groups are hydrolyzable alkoxy groups (in particular, a methoxy group or an ethoxy group).

Hydrocarbon residues denoted by R include, but are not limited to, alkylene groups (for example, methylene, ethylene, trimethylene, propylene, 2,2-dimethyl methylene, tetramethylene, pentamethylene, hexamethylene, and other such linear or branched C₁₋₆ alkylene groups), cycloalkene residues (for example, cycloheptene, cyclohexene, cyclopentene, cyclooctene, and other such C₄₋₁₀ cycloalkene residues), and cycloalkene-alkyl residues (for example, cycloheptene, cyclohexene, cyclopentene, and other such C₄₋₁₀ cycloalkene-C₁₋₆ alkyl groups). Note that cycloalkene residues and cycloalkene-alkyl residues are often residues generated by epoxidation of double bonds as described above. Preferred hydrocarbon residues R include C₁₋₄ alkylene residues (especially C₂₋₄ alkylene residues), and C₅₋₈ cycloalkene-C₁₋₄ alkyl residues (especially cyclohexene-C₂₋₄ alkyl residues). Further, n is 0 or 1. When Y is a vinyl group, n is 0, and when Y is another functional group, n is often 1.

Of these silane coupling agents, a silane coupling agent containing an epoxy group (such as a silane coupling agent in which Y in the formula is an epoxy group) is preferable from the perspective of highly improving interlayer adherence. Examples of the silane coupling agent containing an epoxy group include 2-(3,4-epoxycyclohexyl)ethyl trimethoxysilane, 2-(3,4-epoxycyclohexyl)ethyl triethoxysilane, 3-(3,4-epoxycyclohexyl)propyl trimethoxysilane, 2-glycidyloxyethyl trimethoxysilane, 2-glycidyloxyethyl triethoxysilane, 3-glycidyloxypropyl trimethoxysilane, and 3-glycidyloxypropyl triethoxysilane.

The ratio of the silane coupling agent with respect to a total of 100 parts by weight of the vinylidene chloride copolymer is approximately, for example, from 0.05 to 10 parts by weight (for example, from 0.1 to 10 parts by weight), preferably from 0.1 to 7 parts by weight (for example, from 0.2 to 7 parts by weight), and more preferably from 0.5 to 5 parts by weight (particularly from 0.5 to 3 parts by weight).

(D) Anti-Blocking Agent

From perspectives of productivity and handling ease, the coating layer may contain an anti-blocking agent (blocking preventing agent or particulate lubricant). The anti-blocking agent may be a component having a melting point or softening point higher than the temperature at the time of film forming, and examples include inorganic fine powders (silica, alumina, talc, titanium oxide, calcium carbonate, and the like), high heat resistant thermoplastic resins (such as engineering plastics), crosslinked resins (crosslinked acrylic resins, crosslinked styrene-based resins, crosslinked melamine resins, and the like), and thermosetting resins. Among these, an inorganic fine powder (such as silica), and a crosslinked resin (such as crosslinked polymethyl methacrylate and other such crosslinked acrylic resins, and a crosslinked polystyrene resin and other such crosslinked styrene-based resins) are preferable.

The anti-blocking agent may be amorphous, but is preferably spherical. The average particle size (volume average primary particle size) of the anti-blocking agent can be selected according to the thickness of the coating layer, and is approximately, for example, from 0.1 to 10 μm, preferably from 0.2 μm to 5 μm, and even more preferably from 0.3 to 2 μm.

The ratio of anti-blocking agent may be, per 100 parts by weight of the total of the first and second vinylidene chloride copolymers, 5 parts by weight or less, and may be approximately, for example, from 0.001 to 5 parts by weight, preferably from 0.003 to 1 parts by weight, and even more preferably from 0.005 to 0.5 parts by weight (in particular, from 0.01 to 0.3 parts by weight).

(E) Other Components

Depending on the application, the coating layer may include, as other components, other resin components, reactive adhesive components, and commonly used additives, and the like.

Examples of other resin components include olefinic resins (such as polyethylene-based resins), vinyl alcohol-based resins (such as polyvinyl alcohol or ethylene-vinyl alcohol copolymers), other chlorine-containing resins, styrene-based resins, petroleum resins, and water soluble polysaccharides (such as water-soluble cellulose derivatives, water soluble starches, and chitosan).

Examples of the reactive adhesive component include isocyanate-based compounds (such as tolylene diisocyanate, xylylene diisocyanate, tetramethyl xylylene diisocyanate, diphenylmethane-4,4′-diisocyanate, and other such aromatic isocyanates and derivatives thereof), and imino group-containing polymers (such as polyethyleneimine).

Examples of commonly used additives include stabilizers (such as heat stabilizers, antioxidants, and ultraviolet absorbers), preservatives, bactericides, plasticizers, lubricants, colorants, viscosity modifiers, leveling agents, surfactants, and antistatic agents.

The total ratio of the other components is approximately, for example, 50 parts by weight or less, preferably 30 parts by weight or less (for example, from 0.01 to 30 parts by weight), and more preferably 10 parts by weight or less (for example, from 0.1 to 10 parts by weight), per a total of 100 parts by weight of the first and second vinylidene chloride copolymers.

(F) Coating Layer Thickness

The average thickness of the adhesive layer is approximately, for example, from 0.05 to 20 μm, preferably from 0.1 to 10 μm, and more preferably from 0.2 to 5 μm (particularly, from 0.3 to 2 μm).

Characteristics of the Gas Barrier Film

The gas barrier film according to an embodiment of the present invention has high gas barrier properties and may have a water vapor transmission rate of less than 0.1 g/m²/day at 40° C. and 90% RH, and for example, the water vapor transmission rate thereof may be less than or equal to 0.08 g/m²/day, preferably less than or equal to 0.05 g/m²/day, more preferably less than or equal to 0.04 g/m²/day (for example, from 0.01 to 0.035 g/m²/day), and in particular, less than or equal to 0.035 g/m²/day (for example, from 0.02 to 0.035 g/m²/day).

Note that in the present specification and claims, the water vapor transmission rate can be measured according to JIS K7129, and more specifically, can be measured by a method described in the examples below.

The gas barrier film according to an embodiment of the present invention has high transparency and may have a total light transmittance of approximately 30% or greater, preferably 60% or greater, and more preferably 80% or greater (for example from 80 to 99%). In the present specification and claims, the total light transmittance can be measured according to JIS K7361 using a haze meter (NDH-7000 available from Nippon Denshoku Industries Co., Ltd.).

Method for Producing the Gas Barrier Film

The method for producing a gas barrier film according to an embodiment of the present invention includes a first laminating step of forming an inorganic layer on at least one surface of a substrate layer, and a second laminating step of forming a coating layer on the inorganic layer.

In the first laminating step, an inorganic layer can be formed using a commonly used film forming method capable of forming a thin film containing a metal or metal compound. Examples of the film forming method include physical vapor deposition (PVD) [for example, vacuum deposition, flash deposition, electron beam deposition, ion beam deposition, ion plating (for example, an HCD method, electron beam RF method, an arc discharge method, and the like), sputtering (for example, direct current discharge, high frequency (RF) discharge, a magnetron method, and the like), molecular beam epitaxy, and laser ablation, and the like], chemical vapor deposition (CVD) [for example, thermal CVD, plasma CVD, metal-organic chemical vapor deposition (MOCVD), and optical CVD and the like], ion beam mixing, and ion implantation. Of these film forming methods, physical vapor deposition methods such as vacuum deposition, ion plating, and sputtering, and chemical vapor deposition and the like are widely used, and vacuum deposition is preferable. Note that the laminate of the substrate layer and the inorganic layer may be a commercially available product.

In the second laminating step, a liquid composition for forming the coating layer may be applied, and then dried and further aged.

The liquid composition may contain a solvent (organic solvent) in addition to solid content containing a vinylidene chloride copolymer. The solvent is not particularly limited as long as the solvent can dissolve the vinylidene chloride copolymer, and may be a polar solvent (hydrocarbons that may contain a halogen atom) or a non-polar solvent.

Examples of the non-polar solvent include aliphatic hydrocarbons (pentane, hexane, heptane and other such as C₅₋₁₂ aliphatic hydrocarbons, and the like), alicyclic hydrocarbons (cyclopentane, methylcyclopentane, cyclohexane, methylcyclohexane, and other such C₅₋₈ cycloalkanes which may have an alkyl group, and the like), and aromatic hydrocarbons (such as benzene, toluene, and xylene). Examples of the hydrocarbons containing a halogen atom include chlorinated hydrocarbons [such as halogenated C₁₋₆ aliphatic hydrocarbons (such as chloroform, carbon tetrachloride, and other such chlorinated methanes, and trichloroethane and other such chlorinated ethanes)], hydrocarbons having a chlorine atom and a fluorine atom (such as di chlorodifluoroethane, trichlorodifluoroethane, and trichlorotrifluoroethane), brominated hydrocarbons (such as tetrabromoethane), and iodohydrocarbons (such as carbon tetraiodide).

Examples of polar solvents include dialkyl ketones such as acetone and methyl ethyl ketone, and ethers such as tetrahydrofuran and dioxane.

These solvents can be used alone or in a combination of two or more. Of these solvents, a combination of a non-polar solvent and a polar solvent is preferable, and the weight ratio of both solvents is approximately (non-polar solvent)/(polar solvent)=from 1/99 to 50/50 (particularly, from 10/90 to 40/60). In particular, the non-polar solvent may be an aromatic hydrocarbon (such as toluene). Furthermore, the polar solvent may be a combination of a dialkyl ketone (such as methyl ethyl ketone) and a cyclic ether (such as tetrahydrofuran), and the weight ratio of both is approximately (dialkyl ketones)/(cyclic ethers)=from 1/99 to 50/50 (particularly, from 10/90 to 30/70).

In addition to the solvent, the liquid composition may further contain water in order to improve interlayer adherence. The content percentage of the water in the liquid composition may be 0.1 wt. % or greater (in particular, 0.15 wt. % or greater), and may be approximately, for example, from 0.2 to 1 wt. %, preferably from 0.25 to 0.8 wt. %, and even more preferably from 0.3 to 0.7 wt. % (in particular, from 0.4 to 0.6 wt. %). If the content percentage of the solvent is too low, there is a risk that the effect of improving interlayer adherence may be reduced.

Examples of the coating method include commonly used methods such as a roll coater, an air knife coater, a blade coater, a rod coater, a reverse coater, a bar coater, a comma coater, a die coater, a gravure coater, a screen coater method, a spray method, and a spinner method. Among these methods, methods such as the blade coater method, the bar coater method and the gravure coater method are widely used.

Drying may be natural drying, but the solvent may be evaporated by heating to dryness. The drying temperature is approximately, for example, 160° C. or lower, preferably from 80 to 150° C., and even more preferably from 100 to 140° C. (particularly, from 110 to 130° C.). The drying time may be, for example, 10 seconds or longer, and is preferably about from 0.5 to 5 minutes, and more preferably about from 1 to 3 minutes.

In order to improve adherence between layers, the aging process may involve curing for a prescribed time period in a prescribed environment (temperature and humidity). The temperature may be room temperature, but heating is preferable, and the aging process is preferably performed at a temperature of approximately from 25 to 70° C., more preferably from 30 to 65° C., and even more preferably from 40 to 60° C. The humidity is also not limited, and the aging process may be carried out in dry conditions, but from the perspective of improving the adherence between the layers on an advanced level, wet conditions are preferable, and for example, the humidity may be 30% RH or higher, preferably 50% RH or higher, and even more preferably 80% RH or higher (for example, from 80 to 95% RH). The aging time may be, for example, 5 hours or longer (for example, from 5 to 72 hours), but in the present invention, the aging time may also be short, and may be approximately, for example, from 10 to 48 hours, preferably from 12 to 36 hours, and even more preferably from 18 to 30 hours.

In the present invention, by selecting a substrate layer excelling in flexibility, the gas barrier film can be produced by a roll-to-roll method, and productivity can be improved.

### EXAMPLES

Hereinafter, the present invention is described in greater detail based on examples, but the present invention is not limited to these examples. The characteristics of the gas barrier films obtained in the examples and comparative examples were evaluated by the following methods.

¹³C-NMR Spectrum of Vinylidene Chloride Copolymer

The ¹³C-NMR spectrum of the vinylidene chloride copolymer was measured using a nuclear magnetic resonance apparatus (“AVANCE 600 MHz” available from Bruker Biospin), and using heavy THF as a solvent at a concentration of 50 mg of the vinylidene chloride copolymer per 0.75 mL of THF-d₈, at a measurement temperature of 40° C., and with a number of integration times of 18000.

Water Vapor Barrier Properties

The water vapor transmission rates of the gas barrier films obtained in the examples and comparative examples were measured using a measurement device for water vapor transmission rate (“DELTAPERM”, available from Technolox Ltd.). Measurements were performed at measurement conditions of 40° C. and 90% RH.

Adherence

An adhesive (“TM-570/CAT-RT37” available from Toyo Morton, Ltd.) was applied to the coated surface of the gas barrier films obtained in the examples and comparative examples, and dry laminated with an unstretched polypropylene film (“FHK2” available from Futamura Chemical Co., Ltd., thickness of 30 μm). The obtained laminate film was cut to a width of 15 mm, and the peel strength between the gas barrier film and the unstretched polypropylene film was measured in accordance with the 180 degree peel test method using a tensile tester (“RTC-1210” available from ORIENTEC Co., Ltd.).

Residual Solvent

Four 10 cm×10 cm test pieces were collected from the gas barrier films obtained in the examples and comparative examples, and sealed in a glass bottle. Next, the test pieces were heated for 30 minutes at 100° C., 2 ml of gas inside the container was collected by syringe, the concentration of the organic solvent was quantitatively determined using a gas chromatograph (“GC-2014” available from Shimadzu Corporation), and the concentration of the residual solvent of the gas barrier film was calculated.

Barrier Properties of Liquid Packaging Bag

An adhesive (“TM-570/CAT-RT37” available from Toyo Morton, Ltd.) was applied to the coated surface of each of the gas barrier films obtained in the examples and comparative examples, and dry laminated with an unstretched polypropylene film (“FHK2” available from Futamura Chemical Co., Ltd., thickness of 30 μm). Three sides of two sheets of the obtained laminate film were heat sealed using an impulse sealer (available from Fuji Impulse Co., Ltd.) with the side of the unstretched polypropylene film being oriented to the inside, after which the obtained product was filled with 50 g of distilled water, and then the remaining side was heat sealed to produce a bag with an inner dimension of 10 cm×10 cm. The produced bags were stored in a constant temperature bath at 40° C., and the amount of change in the weight over time (amount of moisture desorption) was measured.

Production of First Vinylidene Chloride Copolymer

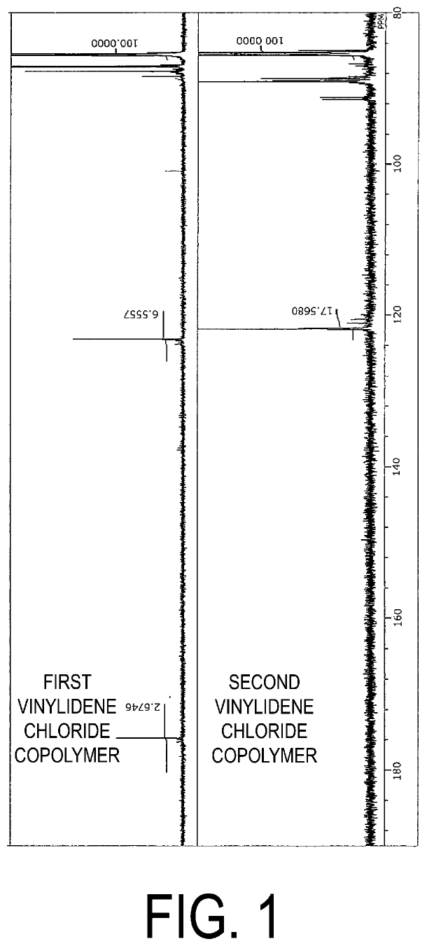

100 parts by weight of distilled water, 0.1 parts by weight of sodium lauryl sulfate, and 0.8 parts by weight of sodium persulfate were mixed and heated to 50° C. To the obtained mixture, 100 parts by weight of a monomer mixture of vinylidene chloride:acrylic acid:methacrylonitrile=91.5:2:6.5 (weight ratio) was added gradually, a reaction was allowed to proceed, and an aqueous dispersion of a vinylidene chloride copolymer was obtained. The obtained aqueous dispersion was added dropwise to a 3 wt. % calcium chloride aqueous solution at 60° C., and the produced aggregates were washed with water and dried to obtain a first vinylidene chloride copolymer. The ¹³C-NMR spectrum of the obtained first vinylidene chloride copolymer is illustrated in FIG. 1. As is clear from FIG. 1, the integral value signals at from 170 to 180 ppm relative to the integral value of signals at 80 to 85 ppm in the ¹³C-NMR spectrum of the first vinylidene chloride copolymer was 0.03.

Production of Second Vinylidene Chloride Copolymer

100 parts by weight of distilled water, 0.1 parts by weight of sodium lauryl sulfate, and 0.8 parts by weight of sodium persulfate were mixed and heated to 50° C. To the obtained mixture, 100 parts by weight of a monomer mixture of vinylidene chloride:methacrylonitrile=90:10 (weight ratio) was added gradually, a reaction was allowed to proceed, and an aqueous dispersion of a vinylidene chloride copolymer was obtained. The obtained aqueous dispersion was added dropwise to a 3% calcium chloride aqueous solution at 60° C., and the produced aggregates were washed with water and dried to obtain a second vinylidene chloride copolymer. The ¹³C-NMR spectrum of the obtained second vinylidene chloride copolymer is illustrated in FIG. 1. As is clear from FIG. 1, signals at from 170 to 180 ppm were not detected in the ¹³C-NMR spectrum of the second vinylidene chloride copolymer.

### Example 1

5 parts by weight of 3-glycidoxypropyltrimethoxy silane (“KBM-403” available from Shin-Etsu Chemical Co., Ltd.) were added to 100 parts by weight of the first vinylidene chloride copolymer (first PVDC), and then dissolved in a mixed solvent of toluene/methyl ethyl ketone/tetrahydrofuran=1/1/2 (weight ratio) to thereby prepare a liquid composition for a coating layer having a PVDC concentration of 15 wt. %. The liquid composition for a coating layer was applied onto a vapor deposited layer of a silica vapor deposited PET film (“Techbarrier”, available from Mitsubishi Chemical Corporation) using a bar coater, and then the coating film was dried for 1 minute in a 120° C. oven. Subsequently, the coating film was aged for one day at a temperature of 40° C. and a humidity of 10% RH, and thereby a gas barrier film (average dry thickness of the coating layer of 1 μm) was produced.

### Examples 2 to 6 and Comparative Example 1

A gas barrier film was produced in the same manner as in Example 1 with the exception that a first vinylidene chloride copolymer and/or a second vinylidene chloride copolymer (second PVDC) was used at the proportions shown in Table 1 instead of the first vinylidene chloride copolymer.

### Example 7

A gas barrier film was produced in the same manner as in Example 1 with the exception that the drying temperature was changed to 100° C.

The results obtained by evaluating the barrier properties, adherence, and residual solvent of the gas barrier films obtained in Examples 1 to 7 and Comparative Example 1 are shown in Table 1.

TABLE 1

| | PVDC | | Drying | Barrier | | Residual |
|---|---|---|---|---|---|---|
| | First | Second | Temperature | Properties | Adherence | Solvent |
| | PVDC | PVDC | (° C.) | (g/m²/day) | (N/15 mm) | (mg/m²) |
| Example 1 | 100 | 0 | 120 | 0.03 | 0.5 | <0.1 |
| Example 2 | 95 | 5 | 120 | 0.03 | 1.3 | <0.1 |
| Example 3 | 90 | 10 | 120 | 0.03 | 2.2 | <0.1 |
| Example 4 | 70 | 30 | 120 | 0.03 | 2.3 | <0.1 |
| Example 5 | 50 | 50 | 120 | 0.04 | 3.2 | <0.1 |
| Example 6 | 30 | 70 | 120 | 0.05 | 3.3 | <0.1 |
| Comparative | 0 | 100 | 120 | 0.1 | 3.5 | <0.1 |
| Example 1 | | | | | | |
| Example 7 | 100 | 0 | 100 | 0.03 | 2.6 | 2.9 |

As is clear from the results shown in Table 1, the gas barrier films of the examples exhibited an excellent balance between the various characteristics.

### Example 8

A gas barrier film was produced in the same manner as in Example 1 with the exception that the film was aged for 3 days.

### Example 9

A gas barrier film was produced in the same manner as in Example 1 with the exception that the film was aged at 40° C. and 90% RH.

The results obtained by evaluating the barrier properties and adherence of the gas barrier films obtained in Examples 8 and 9 are shown in Table 2. The results of Example 1 are also shown in Table 2 for comparison.

TABLE 2

| | PVDC | | Aging | | Barrier | |
|---|---|---|---|---|---|---|
| | First | Second | Temperature, | Aging | Properties | Adherence |
| | PVDC | PVDC | Humidity | (Days) | (g/m²/day) | (N/15 mm) |
| Example 1 | 100 | 0 | 40° C., 10% | 1 day | 0.03 | 0.5 |
| Example 8 | 100 | 0 | 40° C., 10% | 3 days | 0.03 | 0.8 |
| Example 9 | 100 | 0 | 40° C., 90% | 1 day | 0.03 | 3.3 |

As is clear from the results in Table 2, adherence was improved by aging in a wet state.

### Example 10

A gas barrier film was produced in the same manner as in Example 1 with the exception that the liquid composition contained 1000 ppm (weight basis) of water.

### Example 11

A gas barrier film was produced in the same manner as in Example 10 with the exception that the proportion of water was changed to 3000 ppm.

### Example 12

A gas barrier film was produced in the same manner as in Example 10 with the exception that the proportion of water was changed to 5000 ppm.

The results obtained by evaluating the adherence of the gas barrier films obtained in Examples 10 to 12 are shown in Table 3. The results of Example 1 are also shown in Table 3 for comparison.

TABLE 3

| | | | Lacquer | |
|---|---|---|---|---|
| | PVDC | | Water | Adherence |
| | First PVDC | Second PVDC | Addition | (N/15 mm) |
| Example 1 | 100 | 0 | None | 0.5 |
| Example 10 | 100 | 0 | 1000 ppm | 0.8 |
| Example 11 | 100 | 0 | 3000 ppm | 1.0 |
| Example 12 | 100 | 0 | 5000 ppm | 1.7 |

From the results in Table 3, it is clear that the interlayer adherence was improved by adding water as a lacquer.

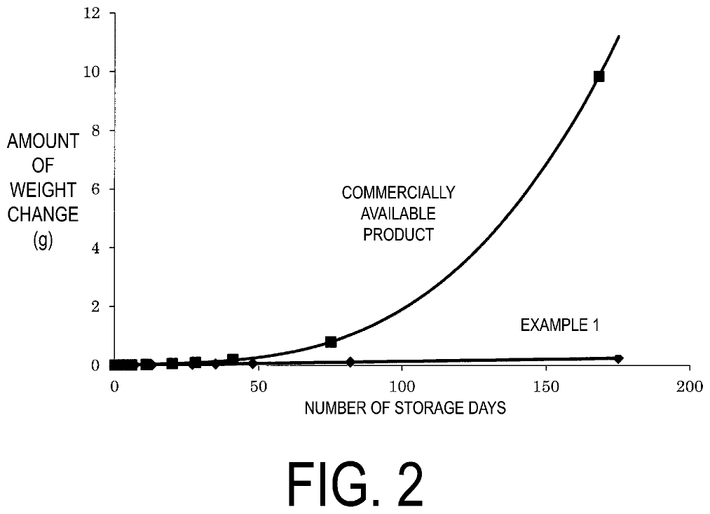

Furthermore, with regard to the gas barrier film obtained in Example 1 and a commercially available gas barrier film (“GX-P-F” available from Toppan Printing Co., Ltd., water vapor transmission rate of 0.05 g/m²/day), the results obtained from evaluation of the barrier properties of the liquid packaging bags are illustrated in FIG. 2. As is clear from FIG. 2, the gas barrier film of Example 1 excelled in moisture desorption prevention property over an extended period of time compared to the commercially available gas barrier film.

### INDUSTRIAL APPLICABILITY

The gas barrier film of the present invention can be used as a film having barrier properties with against gases such as water vapor and oxygen in various fields such as food products, pharmaceuticals, agricultural products, electronic devices, and optical equipment, and for example, the gas barrier film of the present invention can be suitably used as a packaging material for food products, pharmaceuticals, and precision electronic components, and as a constituent material (functional film requiring gas barrier properties) of an electronic device or optical equipment, or the like. In particular, because high gas barrier properties can be maintained over an extended period of time, the present invention is also suitable for applications requiring high moisture proofness and/or moisture desorption prevention properties, including for example, application as a packaging material for pharmaceuticals (for example, a pharmaceutical packaging material that encapsulates a liquid), or a moisture-proof film constituting a solar cell.

1. A gas barrier film comprising: a substrate layer; an inorganic layer covering at least one surface of the substrate layer; and a coating layer covering the inorganic layer and comprising a first vinylidene chloride copolymer containing a carbonyl group.

2. The gas barrier film according to claim 1, wherein in a ¹³C-NMR spectrum of the first vinylidene chloride copolymer, an integral value of signals at from 170 to 180 ppm is at least 0.001 times an integral value of signals at from 80 to 85 ppm.

3. The gas barrier film according to claim 1, wherein the first vinylidene chloride copolymer further comprises a cyano group.

4. The gas barrier film according to claim 1, wherein the coating layer further comprises a second vinylidene chloride copolymer, in the ¹³C-NMR spectrum of which, an integral value of signals at from 170 to 180 ppm is less than 0.001 times an integral value of signals at from 80 to 85 ppm.

5. The gas barrier film according to claim 4, wherein a weight ratio of the first vinylidene chloride copolymer to the second vinylidene chloride copolymer is former/latter=from 99/1 to 30/70.

6. The gas barrier film according to claim 1, wherein the coating layer further comprises a silane coupling agent.

7. The gas barrier film according to claim 1, wherein the inorganic layer is silicon oxide.

8. The gas barrier film according to claim 1, wherein a water vapor transmission rate at 40° C. and 90% RH is less than 0.1 g/m²/day.

9. A production method of the gas barrier film described in claim 1, the method comprising a first laminating step of forming an inorganic layer on at least one surface of a substrate layer, and a second laminating step of forming a coating layer on the inorganic layer.

10. The production method according to claim 9, wherein, in the second laminating step, a liquid composition for forming the coating layer is applied, and then dried and further aged.

11. The production method according to claim 10, wherein aging is performed in a wet state.

12. The production method according to claim 9, wherein a content percentage of water in the liquid composition for forming the coating layer is not less than 0.15 wt. %.
